(19) United States
(12) Patent Application Publication
(10) Pub. No.: US 2013/0040741 A1
(43) Pub. Date: Feb. 14, 2013

(54) JOINT ARRANGEMENT FOR USE IN A MOTOR VEHICLE

(71) Applicants: Paul Hurmer, Stuttgart (DE); Dietmar Becker, Tamm (DE)

(72) Inventors: Paul Hurmer, Stuttgart (DE); Dietmar Becker, Tamm (DE)

(73) Assignee: DR. ING. H.C. F. PORSCHE AKTIENGESELLSCHAFT, Stuttgart (DE)

(21) Appl. No.: 13/568,221

(22) Filed: Aug. 7, 2012

(30) Foreign Application Priority Data
Aug. 8, 2011 (DE) 10 2011 052 474.6

(51) Int. Cl. F16C 1/04

(52) U.S. Cl. 464/97

(57) ABSTRACT

A joint arrangement for use in a motor vehicle includes a joint housing, an input shaft securely connected to the joint housing, a jointed shaft disposed in the joint housing for conjoint rotation by a tripod bearing assembly, and a flexurally elastic connecting arrangement connected to the input shaft by a fixing region. The flexurally elastic connecting arrangement provides at least one defined bending region.

### CROSS REFERENCE TO RELATED APPLICATIONS

This application claims priority to German Patent Application No. DE 10 2011 052 474.6, filed Aug. 8, 2011, which is hereby incorporated by reference herein in its entirety.

### FIELD

The invention relates to a joint arrangement, in particular a constant velocity or tripod joint, for use in a motor vehicle.

### BACKGROUND

There are numerous possible uses of these joint arrangements. In motor vehicles, joint arrangements of this kind are used particularly in homokinetic drive lines, in which high power has to be transmitted, e.g. in motor racing. In one application here, the output axle of the drive line is connected by a joint arrangement of this kind to the jointed shaft, which is, in turn, coupled to a wheel hub.

DE 10 2007 015 413 A1 describes a joint arrangement which provides a flexurally elastic connection piece between the input shaft and the jointed shaft, this being intended to ensure mobility, wherein the flexurally elastic connection piece is arranged both in the input shaft and in the jointed shaft. This joint arrangement has the disadvantage, especially in the case of an embodiment with a connecting rod, that the rod is subjected to such bending loads in the case of large inward and outward deflection travel and sharp steering movements that fracture of the connecting rod may result.

### SUMMARY

In an embodiment, the present invention provides a joint arrangement for use in a motor vehicle including a joint housing, an input shaft securely connected to the joint housing, a jointed shaft disposed in the joint housing for conjoint rotation by a tripod bearing assembly, and a flexurally elastic connecting arrangement connected to the input shaft by a fixing region. The flexurally elastic connecting arrangement provides at least one defined bending region.

### BRIEF DESCRIPTION OF THE DRAWINGS

Exemplary embodiments of the present invention are described in more detail below with reference to the drawings, in which:

FIG. 1 shows a sectional view of an embodiment of a joint arrangement in accordance with the invention, and

FIG. 2 shows a sectional view of another embodiment of a joint arrangement in accordance with the invention.

### DETAILED DESCRIPTION

The present invention relates to a joint arrangement, in particular a constant velocity or tripod joint, for use in a motor vehicle, having a joint housing, an input shaft, which is securely connected to the joint housing, and a jointed shaft, which is arranged in the joint housing for conjoint rotation by means of a tripod bearing assembly, wherein a flexurally elastic connecting arrangement is provided, which connects the input shaft and the jointed shaft to one another, wherein the flexurally elastic connecting arrangement is connected to the input shaft by means of a fixing region.

In an embodiment, the present invention provides a joint arrangement which avoids the abovementioned disadvantage and, while being capable of bearing very high loads, simultaneously ensures high positioning accuracy for the jointed shaft.

In an embodiment, the flexurally elastic connecting arrangement provides at least one defined bending region. In this way, it is possible to provide a joint arrangement which ensures high mobility and, at the same time, high positioning accuracy in a particularly low-cost and simple manner. It is advantageous here if the flexurally elastic connecting arrangement has a flexurally elastic rod-shaped region, which defines the bending region, and a joint head for supporting the elastic connecting arrangement by means of a joint in the jointed shaft. In order to keep the wear on the joint as low as possible and to minimize the bending load on the bending region, it is advantageous if the joint is designed as a ball joint, the central point of which coincides with the central point of the tripod bearing assembly. In this case, the joint can have a two-shell mating part, wherein the joint head is secured axially in the mating part by means of a retention ring.

In order to define the bending region even more clearly, the rod-shaped region can be of at least partially tapered design. In order to achieve a further minimization of the bending stress, it is also possible for the rod-shaped region to be of at least partially ellipsoidal design.

Provision can furthermore be made for the fixing region to have an elastically deformable diaphragm, in particular as a cover element, which forms an elastic bending region in a simple and low-cost manner. In this case, the diaphragm can furthermore close off the joint housing in a fluidtight manner.

Provision can furthermore be made for the flexurally elastic connecting arrangement to be axially preloaded. In this case, a tensioning element can be provided, which is connected to the fixing region by a threaded joint and which is supported on an axial surface of the input shaft.

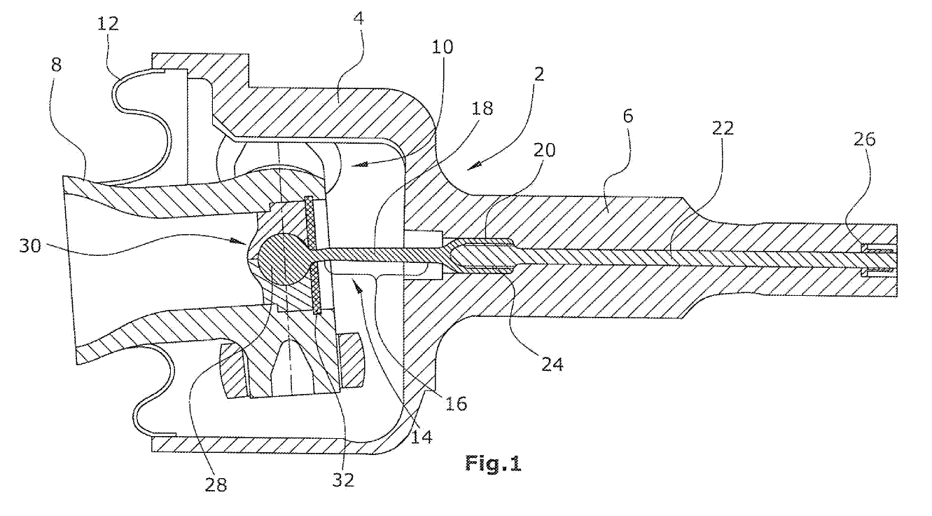

FIG. 1 shows a sectional view of a joint arrangement 2 according to the invention for use in a motor vehicle. The illustrated joint arrangement 2 is used, in particular, to connect a wheel hub to a drive line of the motor vehicle. For this purpose, the joint arrangement 2 has a joint housing 4, which, in the embodiment under consideration, is connected integrally to an input shaft 6, which input shaft 6 can represent an output shaft of the drive line. A jointed shaft 8 is arranged in a known manner in the joint housing 4 by means of a tripod bearing assembly 10. A diaphragm 12 ensures flexible sealing of the joint housing 4 here.

In order to ensure a high degree of mobility combined with highly reliable positioning of the input shaft 8, a flexurally elastic connecting arrangement 14 is provided. According to an embodiment of the invention, this flexurally elastic connecting arrangement 14 has a defined bending region 16. In the first illustrative embodiment, the flexurally elastic connecting arrangement 14 consists of a rod-shaped region 18, which is of slightly tapered design in order to define the bending region 16. In an embodiment, it is furthermore also possible to make at least part of the rod-shaped region 18 ellipsoidal in order to further minimize the bending stresses. The rod-shaped region has a fixing region 20, which is arranged securely in the input shaft 6. In the present case, this connection is established by means of a tensioning element 22, which is connected to the fixing region 20 by a thread 24. The tensioning element 22 is supported in a known manner on an axial surface 26 in such a way that rotation of the tensioning element 22 exerts an axial preload on the connecting arrangement 14.

Moreover, the rod-shaped region 20 has a joint head 28, which is designed as a spherical head in the embodiment shown in FIG. 1. This spherical head 28 is supported in a two-shell mating part 30 and is secured axially by a retention ring 32. Deflection of the jointed shaft 8 in relation to the input shaft 6, during the inward or outward deflection of a wheel for example, then causes only defined bending in the bending region 16. The preloading of the connecting arrangement 18 can be achieved in a particularly simple manner by means of the tensioning element 22, which is passed through the input shaft 6. In this way, the input shaft 6 and the jointed shaft 8 are connected to one another by the connecting arrangement 14 in a manner resistant to compression and tension.

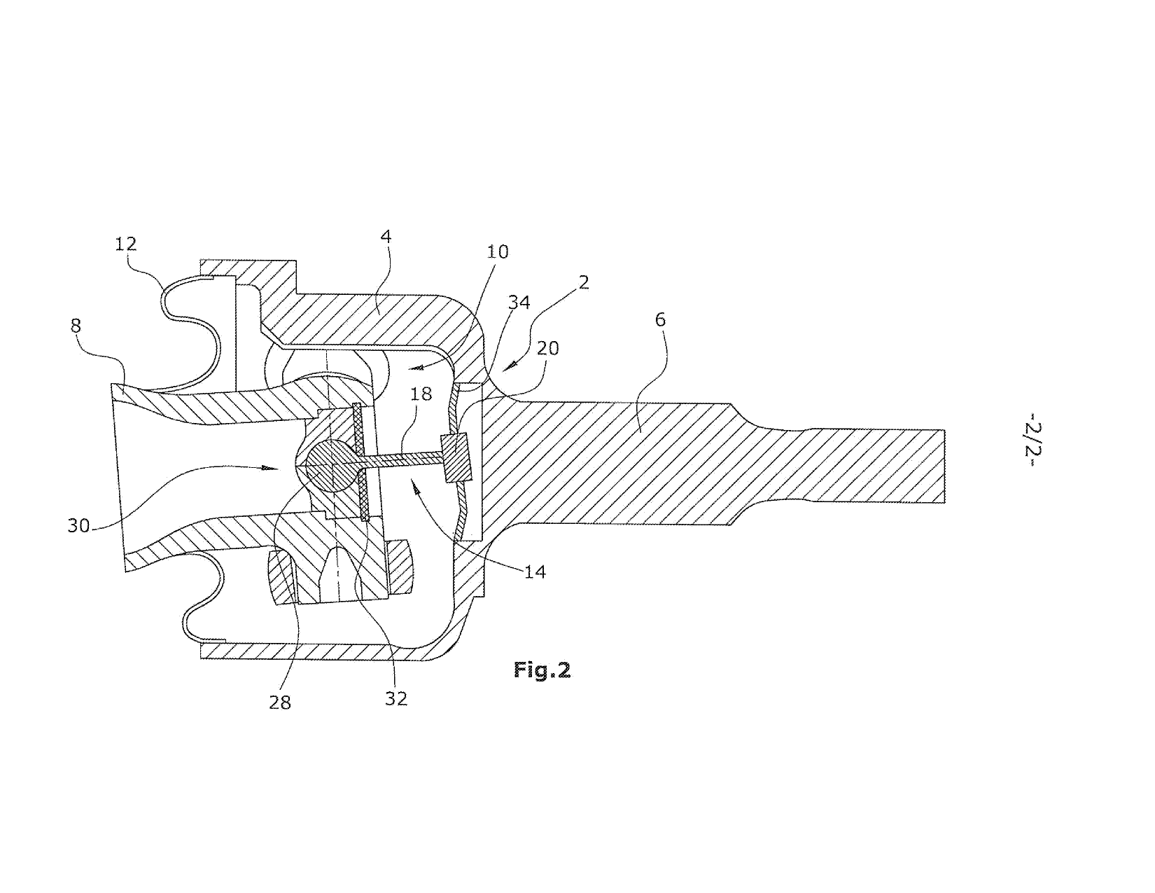

FIG. 2 shows a sectional view of another embodiment of the joint arrangement 2 according to the invention. Here too, the input shaft 6 is again formed integrally with the joint housing 4. In the present case too, the flexurally elastic connecting arrangement 18 is arranged in a two-shell joint head 30 by way of a ball joint 28 and secured axially by a retention washer 32. In the present case, however, the fixing region 20 has an elastically deformable diaphragm 34, which forms the bending region in this illustrative embodiment. An embodiment of this kind offers the advantage, in particular, that the rod-shaped region 18 can be made shorter and stiffer. Moreover, the jointed shaft can also still be sealed off fluidtightly by means of a diaphragm 34 of this kind, which acts as a cover element.

It is, of course, also conceivable to combine the two embodiments shown in FIG. 1 and FIG. 2 in order to further minimize the bending load in the respective bending regions.

While the invention has been particularly shown and described with reference to preferred embodiments thereof, it will be understood by those skilled in the art that various changes in form and details may be made therein without departing from the spirit and scope of the invention.

1: A joint arrangement for use in a motor vehicle, the joint arrangement comprising:
a joint housing;
an input shaft securely connected to the joint housing;
a jointed shaft disposed in the joint housing for conjoint rotation by a tripod bearing assembly; and
a flexurally elastic connecting arrangement connected to the input shaft by a fixing region, the flexurally elastic connecting arrangement providing at least one defined bending region.

2: The joint arrangement recited in claim 1, wherein the flexurally elastic connecting arrangement includes:
a flexurally elastic rod-shaped region defining the bending region, and
a joint head configured to support the flexurally elastic connecting arrangement by a joint in the jointed shaft.

3: The joint arrangement recited in claim 2, wherein the joint is formed as a ball joint and includes a central point coinciding with a central point of the tripod bearing assembly.

4: The joint arrangement recited in claim 2, wherein the joint includes a two-shell mating part, and
wherein the joint head is secured axially in the mating part by a retention ring.

5: The joint arrangement recited in claim 3, wherein the joint includes a two-shell mating part, and
wherein the joint head is secured axially in the mating part by a retention ring.

6: The joint arrangement recited in claim 2, wherein at least a portion of the rod-shaped region is at least partially tapered.

7: The joint arrangement recited in claim 3, wherein at least a portion of the rod-shaped region is at least partially tapered.

8: The joint arrangement recited in claim 4, wherein at least a portion of the rod-shaped region is at least partially tapered.

9: The joint arrangement recited in claim 2, wherein at least a portion of the rod-shaped region is at least partially ellipsoidal.

10: The joint arrangement recited in claim 3, wherein at least a portion of the rod-shaped region is at least partially ellipsoidal.

11: The joint arrangement recited in claim 4, wherein at least a portion of the rod-shaped region is at least partially ellipsoidal.

12: The joint arrangement recited in claim 9, wherein a diaphragm closes off the jointed shaft in a fluidtight manner.

13: The joint arrangement recited in claim 1, wherein the flexurally elastic connecting arrangement is axially preloaded.

14: The joint arrangement recited in claim 2, wherein the flexurally elastic connecting arrangement is axially preloaded.

15: The joint arrangement recited in claim 3, wherein the flexurally elastic connecting arrangement is axially preloaded.

16: The joint arrangement recited in claim 4, wherein the flexurally elastic connecting arrangement is axially preloaded.

17: The joint arrangement recited in claim 6, wherein the flexurally elastic connecting arrangement is axially preloaded.

18: The joint arrangement recited in claim 9, wherein the flexurally elastic connecting arrangement is axially preloaded.

19: The joint arrangement recited in claim 12, wherein the flexurally elastic connecting arrangement is axially preloaded.

20: The joint arrangement recited in claim 13, further comprising a tensioning element connected to the fixing region by a threaded joint, the tensioning element being supported on an axial surface of the input shaft.
